(19) United States
(12) Patent Application Publication
(10) Pub. No.: US 2023/0243767 A1
(43) Pub. Date: Aug. 3, 2023

(54) METHOD AND SYSTEM FOR SPECTROSCOPIC ANALYSIS

(71) Applicant: FEI Company, Hillsboro, OR (US)

(72) Inventor: Garrett Budnik, Hillsboro, OR (US)

(73) Assignee: FEI Company, Hillsboro, OR (US)

(21) Appl. No.: 17/590,565

(22) Filed: Feb. 1, 2022

(51) Int. Cl. G01N 23/2258

(52) U.S. Cl. CPC G01N 23/2258; G01N 2223/081

(57) ABSTRACT

Methods and systems for spectroscopic analysis of focused ion beam induced optical emission include accessing a spectrum acquired from a sample responsive to irradiating the sample with an ion beam and identifying the spectral peaks of the spectrum. The emission type of the spectral peak is determined based on a spectral resolution of a light collection system for collecting the spectrum. The emission types include elemental emission, molecular emission, and bandgap emission.

### FIELD OF THE INVENTION

The present description relates generally to methods and systems for determining sample composition via spectroscopic analysis, and more particularly, to performing analysis on signals collected from focused ion beam induced optical emission.

### BACKGROUND OF THE INVENTION

Charged particle microscopy is a well-known and increasingly important technique for imaging microscopic objects. Emissions from a sample responsive to charged particle irradiation may provide structural and compositional information of the sample. For example, compositional information may be determined using charged particle based spectroscopic techniques such as energy-dispersive X-ray spectroscopy (EDS or EDX), secondary ion mass microscopy (SIMS), and cathodoluminescence. Focused ion beam induced optical emission (FIB-IOE) may provide additional information on sample composition.

### SUMMARY

In one embodiment, a method for spectroscopic analysis comprises: accessing a spectrum of photons emitted from a sample responsive to irradiating the sample with an ion beam; identifying one or more peaks of the spectrum; and determining an emission type of at least one peak of the one or more peaks based on a spectral resolution of a light collection system used for collecting the spectrum, wherein the emission type includes an elemental emission, a molecular emission, and a bandgap emission. In this way, various emission types that contributed to the signals of focused ion beam induced optical emission may be identified. The elemental composition corresponding to the elemental and molecular emissions may be further identified.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 illustrates a charged particle microscope for focused ion beam induced optical emission (FIB-IOE), according to some embodiments.

FIG. 2 is a method for spectroscopic analysis on spectrum acquired from FIB-IOE.

FIG. 3 shows a method for identifying elements corresponding to peaks resulted from elemental emission.

FIG. 4 shows a method for analyzing peaks with width greater than a spectral resolution of a light collection system for acquiring the spectrum.

FIG. 5 shows a method for compositional analysis of the sample based on further collected data.

FIG. 6 shows a method for determining sample composition based on spectra acquired at different removal rates.

FIG. 7 is a spectrum acquired using the system shown in FIG. 1.

FIG. 8 are two spectra of a sample acquired at different removal rates.

Like reference numerals refer to corresponding parts throughout the several views of the drawings.

### DETAILED DESCRIPTION

The following description relates to systems and methods for performing spectroscopic analysis on signals of focused ion beam ion-induced optical emission (FIB-IOE) or focused ion beam induced light emission (FIB-iLE). The FIB-IOE signals include photons with wavelengths spanning from visible to in-visible wavelengths. Signals from FIB-IOE are difficult to be analyzed because multiple types of emissions may contribute to the signals. These emission types including elemental emission, molecular emission, and bandgap emission. Signals from all of these emission types may overlap and affect each other, therefore making it difficult to identify the elemental composition in the sample.

In order to address the above issue, a method for spectroscopic analysis of FIB-IOE data may include identifying spectral peaks in the acquired spectrum and determining emission types corresponding to the peaks (i.e. spectral peaks). Identifying the spectral peaks may include determining a location (energy or wavelength) and a width of each peak. The emission types include elemental emission, wherein photons are emitted from a chemical element; molecular emission, wherein photons are emitted from a molecule; and bandgap emission, wherein photons are emitted when electrons excited by the incident ion are de-excited in samples through electron-hole recombination. The elemental emission includes photons emitted from a neutral or a charged element (i.e. charged atom) sputtered by the ion beam. Determining the emission type corresponding to a particular peak includes selecting an emission type from a group consisting of an elemental emission, a molecular emission, and a bandgap emission. Compositional information can further be extracted based on the determined emission type. For example, elemental composition can be determined for peaks corresponding to elemental and molecular emissions, and electronic structure of the bulk conduction and valence bands or defect states can be determined for peaks corresponding to bandgap emission.

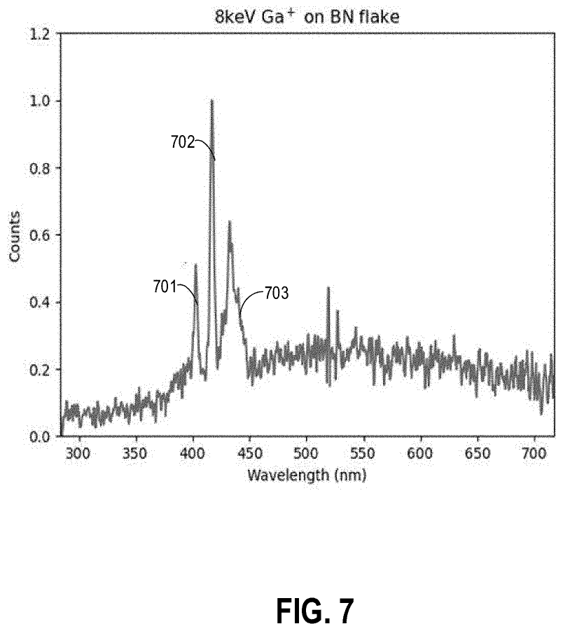

Different emission type contributes to spectral peaks of one or more different location, width, and intensity. The spectral peak from elemental emission is narrower because atomic transitions are quantized and discrete. The spectral peak from molecular emission or bandgap emission is broader than the spectral speak from elemental emission. The molecular emission involves multiple discrete transitions due to the vibrational, rotational, and rovibrational energy sub-levels of a given energy level. In bandgap emission, the electron may originate from defect or virtual states higher or lower than the energy difference of the bandgap, resulting in a continuous range of energy transitions. For example, FIG. 7 shows a FIB-IOE spectrum acquired from a Boron Nitride (BN) flake using Ga+ beam at 8 keV beam energy. Peaks of different widths and locations are observed. The narrow peaks 701 and 702 may be generated from elemental emission, while broad peak 703 may be generated from molecular emission or elemental emissions from multiple elements with similar emission energies (wavelengths).

Each identified peak may be analyzed to determine the corresponding emission type that contributes to the peak. In one example, the emission type may be determined based on a spectral resolution of a light collection system for collecting the spectrum. Peaks with a width not greater than the spectral resolution may correspond to elemental emission. The elemental composition of these peaks may then be identified by comparing the spectrum with an element database. The element database may be constructed to include data corresponding to element candidates. The element candidates are determined for example based on user input and/or previous experiments on a sample with similar composition. The element database may also be constructed based on a removal rate at which the spectrum is acquired. The element database may include data from a standard atomic database and/or a standard ionic database.

The identified peaks that have a width greater than the spectral resolution may result from molecular emission, band gap emission, or combined elemental emissions. Combined elemental emission is a special case of elemental emission, wherein more than one element, wherein the energy difference of the transitions from the different elements falls below the minimum separation distance determined by the linear dispersion of the spectroscopic system (e.g. the light collection system), such that peaks of the different elements may overlap with each other at the image plane. The spectrum with a width greater than the spectral resolution may first be compared with a molecular database to identify molecular emission. The spectrum may then be compared with data from an element database to identify combined elemental emissions from multiple elements. The peak that is not resulted from either the molecular emission or the combined elemental emissions may be determined as the bandgap emission. In this way, all three types of emissions contributed to the FIB-IOE signals can be identified. Further, elements and molecules corresponding to the emission types can be determined by comparing the spectrum with data from the databases. Comparing the spectrum with data from databases may include eliminating candidates from the databases when the corresponding data from the database do not match the spectrum.

In some examples, narrower peaks, such as peaks with width not greater than the spectral resolution, are analyzed in a first step to confirm the presence of one or more elements in the sample. Broader peaks, such as peaks with width greater than the spectral resolution, are analyzed in a second step to identify molecular emission, bandgap emission, and combined elemental emission. The confirmed elements in the first step may facilitate interpreting the broader peaks in the second step.

In one example, the emission type may be determined based on a removal rate of surface atoms of the sample while acquiring the spectrum. The removal rate may have a unit of number of atoms per sample area. The removal rate may be adjusted by adjusting one or more of the ion flux at the sample plane, ion mass/species, and beam energy. The ion flux may be adjusted by adjusting one or more of beam current, current density, dwell time, or scanned surface area. Applicant recognizes that spectra acquired from the same sample at different removal rates may be different, that is, locations of the spectral peaks and/or relative intensity among the peaks are different. At a higher removal rate, the charged element generated a different spectrum comparing the spectrum of generated by the neutral element at the lower removal rate. For this reason, element database for identifying the elemental composition may be constructed based on the removal rate. For example, based on the element candidates and the removal rate, selective data from a standard ionic database may be included into the element database.

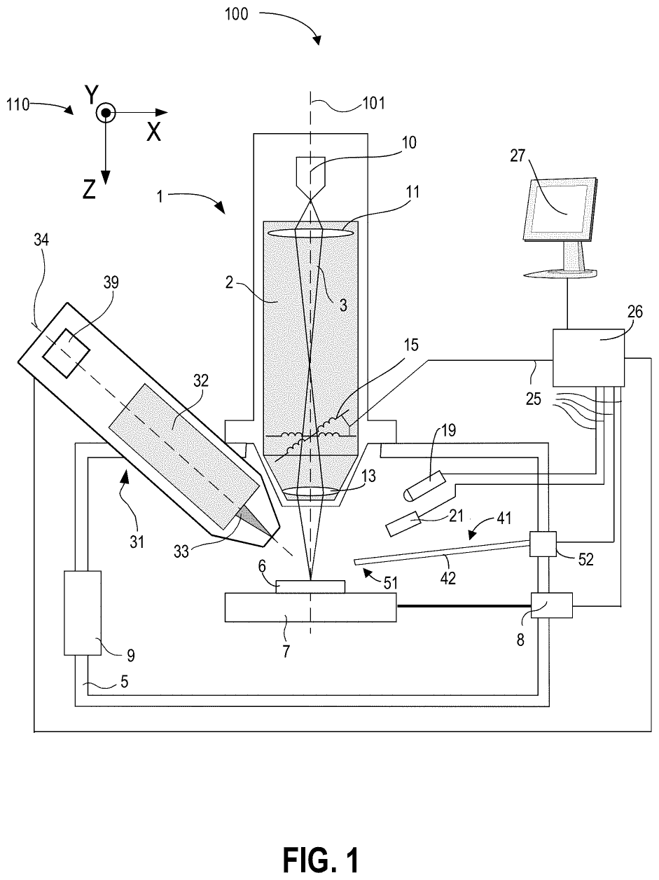

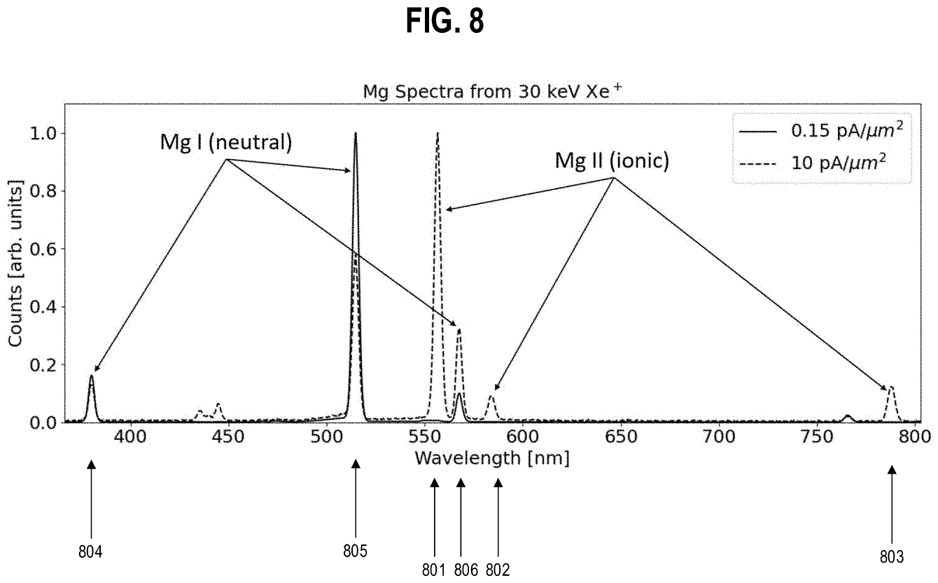

FIG. 8 shows FIB-IOE spectra acquired at the same location (i.e. same X-Y coordinates in the sample plane) from a Mg sample, using the system shown in FIG. 1, with a 30 keV Xe+ beam. One spectrum was acquired at the ion flux of 0.15 pA/um² and another spectrum was acquired at the ion flux of 10 pA/um². The spectrum acquired at the lower ion flux corresponds to neutral Mg I, and the spectrum acquired at the higher ion flux corresponds to ionic Mg II. Both spectra have peaks at wavelengths 804, 805 and 806, but of different intensities. At the higher ion flux, the spectrum of Mg II includes new peaks 801, 802, and 803, that are not observed in the spectrum acquired at the lower ion flux.

In one example, elemental composition of a sample may be determined by comparing a first spectrum acquired at a first removal rate and a second spectrum acquired at a second removal rate. The first and second spectra may be acquired from the same sample position, or different sample positions with similar sample composition. In one example, comparing the first and second spectra may include comparing the changes of peaks in the spectra with the expected change of peaks with respect to the removal rate. In another example, comparing the first and second spectra may include comparing the changes of peaks in the spectra with the expected changes between neutral and charged elements. In some examples, the first spectrum is acquired at a lower removal rate before acquiring the second spectrum at a higher removal rate. In this way, elemental composition may be reliably determined or further confirmed.

In one embodiment, the spectral analyses disclosed herein may be performed using a controller of a charged particle microscope, such as the microscope shown in FIG. 1. In another embodiment, the spectral analyses may be performed by a computer not a part of the microscope shown in FIG. 1, or a computer positioned at a different location from the microscope. The computer performs the spectral analyses disclosed herein by executing computer readable instructions. The computer may access the spectral data acquired by receiving the data from a charged particle microscope, such as the microscope shown in FIG. 1. Alternatively, the computer may access stored spectral data from a data storage device such as a server, or from cloud storage.

Turning to FIG. 1, FIG. 1 is a highly schematic depiction of an embodiment of a dual-beam charged particle microscope (CPM). Coordinate 110 is system coordinate. Microscope 100 comprises a particle-optical column 1, which produces a beam 3 of charged particles (in this case, an electron beam) that propagates along electron-optical axis 101. Electron-optical axis 101 may be aligned with the Z axis of the system. The column 1 is mounted on a vacuum chamber 5, which comprises a sample holder 7 and associated actuator(s) 8 for holding/positioning a sample 6 at a sample plane. The vacuum chamber 5 is evacuated using vacuum pumps (not depicted). Also depicted is a vacuum port 9, which may be opened to introduce/remove items (components, samples) to/from the interior of vacuum chamber 5. Microscope 100 may comprise a plurality of such ports 9, if desired.

The electron column 1 comprises an electron source 10 and an illuminator 2. The illuminator 2 comprises lenses 11 and 13 to focus the electron beam 3 onto the sample 6, and a deflection unit 15 (to perform beam steering/scanning of the beam 3). The microscope 100 further comprises a controller/computer processing apparatus 26 for controlling inter alia the deflection unit 15, lenses 11, 13 and detectors 19, 21, and 41, and displaying information gathered from the detectors 19, 21, and 41 on a display unit 27.

The detectors 19, 21 may be chosen from a variety of possible detector types that can be used to examine different types of “stimulated” radiation emanating from the sample 6 in response to irradiation by the (impinging) electron beam 3. It could alternatively be an X-ray detector, such as Silicon Drift Detector (SDD) or Silicon Lithium (Si(Li)) detector, for example. Detector 21 may be an electron detector in the form of a Solid State Photomultiplier (SSPM) or evacuated Photomultiplier Tube (PMT) for example. This can be used to detect backscattered and/or secondary electrons emanating from the sample 6. Microscope 100 may also include an ion detector and a mass analyzer for SIMS imaging. The skilled artisan will understand that many different types of detector can be chosen in a set-up such as that depicted, including, for example, an annular/segmented detector.

Detector 41 is a FIB-IOE detector for detecting photon emission responsive to FIB irradiation. In one example, detector 41 includes a retractable light collection system 42 for detecting photon emissions from sample 6. The photon emissions may be resulted from ion and/or electron beam irradiation on the sample surface. The light collection system 42 may be introduced to the vacuum chamber 5 via flange 52 on the vacuum chamber 5. Photons collected by the first distal end 51 of the light collection system 42 may be converted and amplified by an imaging sensor before transferring to controller 26. The retractable FIB-IOE detector is disclosed in U.S. patent application Ser. No. 17/490,412 by Budnik et al., filed on Sep. 30, 2021. In another example, detector 41 includes a mirror based light collection system disclosed in US patent U.S. Pat. No. 10,692,694B2 by Gledhill et al, wherein light emitted from sample is reflected from a mirror before being collected by an optical detection arrangement. Both patent application Ser. No. 17/490,412 and patent U.S. Pat. No. 10,692,694B2 are incorporated by reference in their entirety, and for all purposes.

By scanning the beam 3 over the sample 6, stimulated radiation—comprising, for example, X-rays, infrared/visible/ultraviolet light, secondary electrons (SEs) and/or backscattered electrons (BSEs)—emanates from the sample 6. Since such stimulated radiation is position-sensitive (due to said scanning motion), the information obtained from the detectors 19, 21 and 41 will also be position-dependent.

The signals from the detectors (19, 21 and 41) pass along control lines (buses) 25, are processed by the controller 26, and displayed on display unit 27. Such processing may include operations such as combining, integrating, subtracting, false coloring, edge enhancing, and other processing known to the skilled artisan. In addition, automated recognition processes (e.g. as used for particle analysis) may be included in such processing. The processing may include analyzing signals and extracting compositional information of the sample. The controller includes a non-transitory memory for storing computer readable instructions, and a processor for executing the computer readable instructions. Methods disclosed herein may be implemented by executing the computer readable instructions in the processor. For example, the controller may access the spectral data by receiving one or more spectra from the light collection system. By executing the computer readable instructions with the processor, the controller may perform the spectral analyses disclosed herein and output results to the display unit.

In addition to the electron column 1 described above, the microscope 100 also comprises an ion column 31. This comprises an ion source 39 and an illuminator 32, and these produce/direct a focused ion beam (FIB) 33 along an ion-optical axis 34. To facilitate easy access to sample 6 on holder 7, the ion-optical axis 34 is canted relative to the electron-optical axis 101. As hereabove described, such ion column 31 can, for example, be used to perform processing/machining operations on the sample 6, such as incising, milling, etching, depositing, etc. Additionally, the ion column 31 can be used to produce imagery of the sample 6. It should be noted that ion column 31 may be capable of generating various different species of ion; accordingly, references to ion beam 33 should not necessarily been seen as specifying a particular species in that beam at any given time—in other words, the ion beam 33 might comprise ion species A for operation A (such as milling) and ion species B for operation B (such as implanting), where species A and B can be selected from a variety of possible options.

The microscope may include a Gas Injection System (GIS), which can be used to effect localized injection of gases, such as etching or precursor gases, etc., for the purposes of performing gas-assisted etching or deposition. Such gases can be stored/buffered in a reservoir and can be administered through a narrow nozzle, so as to emerge in the vicinity of the intersection of axes 101 and 34, for example. The GIS system may be introduced to vacuum chamber 5 via the same flange 52 as for introducing the retractable FIB-IOE detector.

It should be noted that many refinements and alternatives of such a set-up will be known to the skilled artisan, such as the use of a controlled environment within (a relatively large volume of) the microscope 100, e.g. maintaining a background pressure of several mbar (as used in an Environmental SEM or low-pressure SEM).

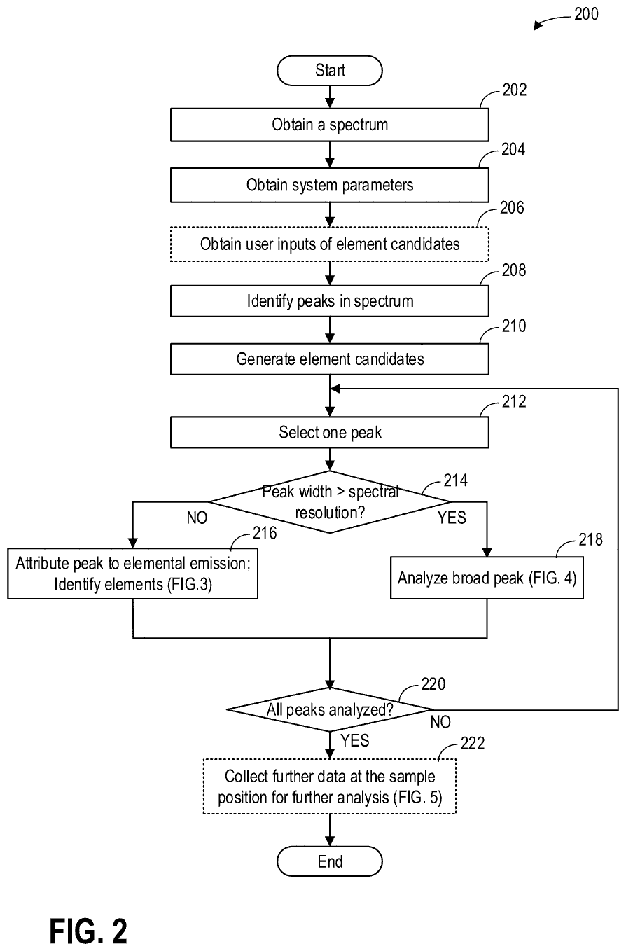

FIG. 2 shows method 200 for spectroscopic analysis on FIB-IOE data. To determine the elemental composition corresponding to a FIB-IOE spectrum, peaks in the spectrum are first identified. The identified peak is then attributed to one of the emission types including elemental emission, molecular emission and bandgap emission. The emission types are determined based on the spectral resolution of the light collection system used for collecting the spectrum. For example, identified peaks with a width not greater than the spectral resolution are determined to be elemental emission, and corresponding elements are then determined. Then, emission type of identified peaks with a width greater than the spectral resolution is determined. The identified peak that is not determined to be either the elemental emission or molecular emission is determined to correspond to bandgap emission. Method 200 may be executed during FIB-IOE spectrum acquisition or after the FIB-IOE data have been acquired.

At 202, a spectrum is obtained. The spectrum may be stored in a memory (such as the memory of the controller of FIG. 1), or a storage device. The spectrum may be just acquired from a detector of a CPM. The spectrum may be obtained by accessing the memory or the detector, and then loaded into a processor for performing the spectroscopic analysis. In some examples, a dataset including multiple spectra of a sample may be obtained.

At 204, system parameters for acquiring the spectrum at 202 are obtained. The system parameters may include system settings including ion flux at the sample plane, beam energy, and ion mass. The removal rate may be estimated based on the system settings. The system parameters may include hardware parameters of the light collection system. For example, for a light collection system with retractable fibers, the hardware parameters may include the fiber parameters such as fiber split and fiber gritting, as well as the spectrometer parameters. Step 204 may include determining spectral resolution of the light collection system based on the hardware parameters. For example, for a retractable light collection system, the spectral resolution may be determined based on one or more of groove density, entrance aperture, fiber core size, and detector pixel size. In some examples, the spectral resolution of the light collection system may be experimentally determined and saved as a system parameter. The system parameters may be obtained from user input and/or saved system parameters in the memory of the CPM.

At 206, user inputs of element candidates are optionally obtained. The user inputs may include a list of element candidates that the user expected to be included in the sample under investigation. The user may input the list or select among existing lists. Alternatively, or additionally, the user may input the element candidates by selecting a similar sample that have be analyzed previously.

At 208, peaks of the spectrum obtained at 202 are identified. Identifying the peaks includes determining the location (wavelength or energy) of the peak and the width of the peak. The width may be the full width half maximum (FWHM) of the peak. In one example, a peak is observed in the spectrum when the maximum signal amplitude is greater than a threshold signal level (such as noise level). In another example, the peak can be identified by various peak-like fitting methods, such as Gaussian, Lorentzian, Voigt, etc.

At 210, element candidates are generated. The element candidates include the element candidates obtained at 206. Method 200 may also add elements from similar samples or previously analyzed samples. In some examples, the element candidates may include all or a subset of elements in the elemental database. Through steps 212 to 220, the identified peaks in 208 are analyzed to determine the corresponding emission type and elemental composition.

At 212, one of the identified peaks at 208 is selected. In one example, narrower peaks, such as peaks with a width not greater than the spectral resolution of the light collection system, are selected before selecting the broader peaks (i.e. peaks with a width greater than the spectral resolution of the light collection system).

At 214, the peak width of the selected peak is compared with the spectral resolution of the light collection system. If the peak width is not greater than the spectral resolution, method 200 proceeds to 216. If the peak width is greater than the spectral resolution at 214, method 200 proceeds to 218.

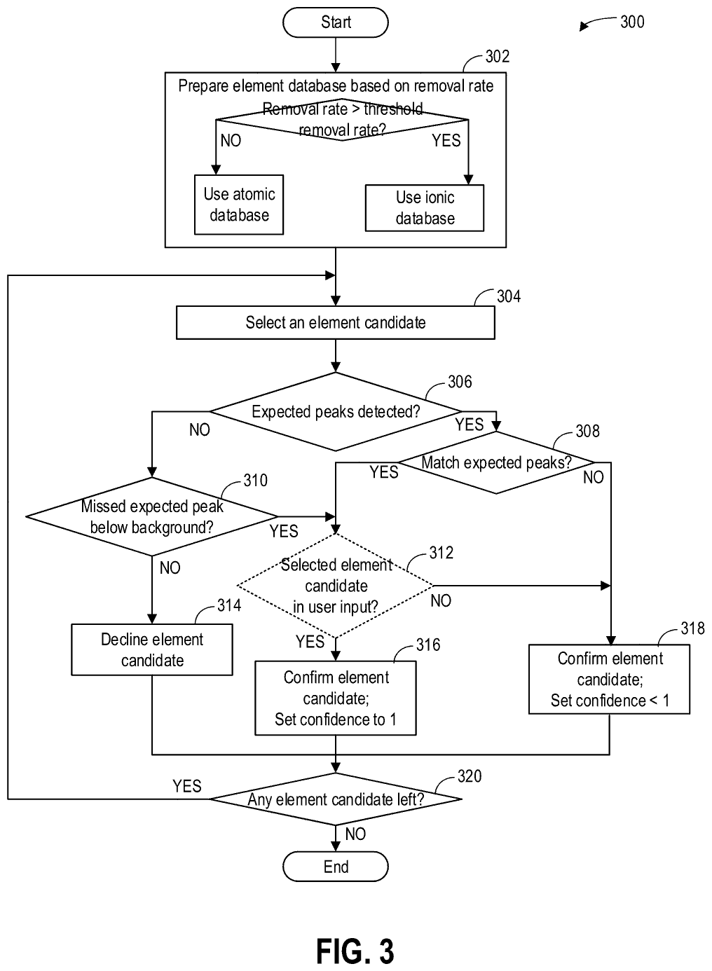

At 216, the emission type of the peak is determined to be elemental emission, and elements corresponding to the peak is also identified. The details for elemental identification for elemental emission are presented in FIG. 3. Sometimes, elemental emission from a particular element may generate multiple peaks. Therefore, emission type as well as the corresponding element can be determined for multiple peaks at 216. All peaks corresponding to the identified element may be set as already been analyzed, and the analyzed peaks won't be selected at 212 in the following spectroscopic analysis.

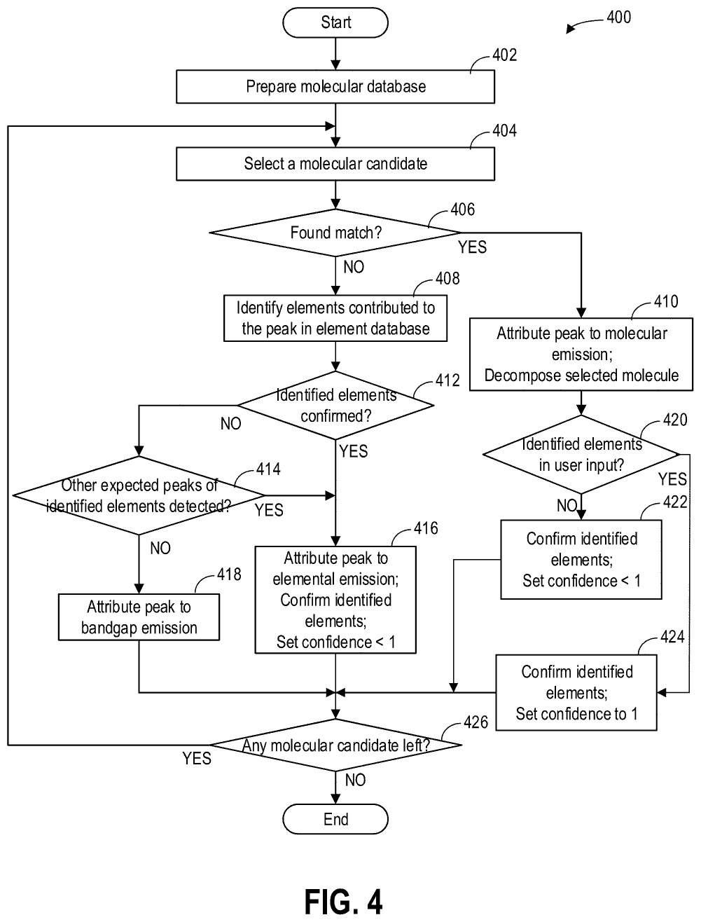

At 218, emission type as well as the elemental composition of the broad peak are determined. Details of step 218 are presented in FIG. 4. In particular, step 218 first determines whether the emission type of the selected peak is molecular emission or combined elemental emissions. If the selected peak matches the molecular emission or combined elemental emissions, elements corresponding to the peak are further identified. If the selected peak does not match either the molecular emission or combined elemental emissions, the selected peak is determined to be from bandgap emission.

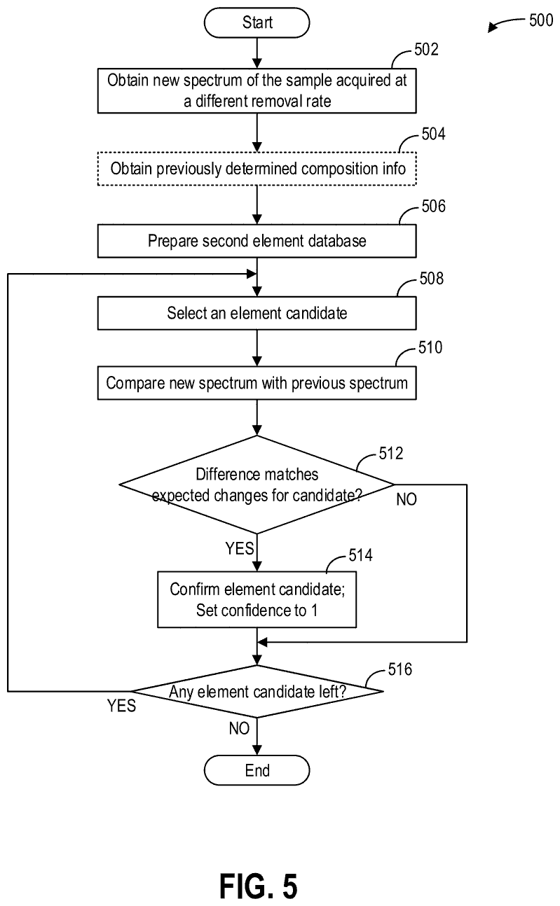

At 220, method 200 checks whether all identified peaks at 208 have been analyzed. If the answer is YES, method 200 may optionally move to 222, to further confirm one or more identified elements at 216 or 218 by collecting more spectroscopic data at a different removal rate. The details for compositional analysis of the further collected data are presented in FIG. 5. If the answer is NO, method 200 moves to 212 to select another identified peak.

In this way, emission type of each spectral peak can be determined. If the emission type is elemental emission or molecular emission, elemental composition is further determined.

FIG. 3 shows method 300 for identifying elements corresponding to the elemental emission. The elements are identified using an element database including data of the element candidates. The data in the database may include locations of the spectral peaks, relative peak intensities of a particular element candidate, and the corresponding removal rate. The elements are identified through eliminating element candidates by comparing the spectrum with data from the element database. In some examples, the element database may include data of both neutral and charged elements. The element database may include data selected from a standard atomic database and a standard ionic database, based on the removal rate associated with the spectrum.

At 302, the element database for determining elemental composition corresponding to the spectral peak (such as the selected spectral peak at 212 of FIG. 2) is prepared. Preparing the element database includes selecting data from known databases based on one or more of the element candidates generated at 210 of FIG. 2, the removal rate used for acquiring the spectrum, sample type, and the vacuum level of the sample chamber. The known databases include standard atomic and standard ionic databases. The known databases may further include customized databases generated with experimental results. In one example, the removal rate for acquiring the spectrum is compared with a threshold removal rate. If the removal rate is greater than the threshold removal rate, data of element candidates in the standard ionic database are included in the element database. The ionic database includes known spectral data of charged elements. If the removal rate is not greater than the threshold removal rate, data of element candidates in the standard atomic databased are included in the element database. The atomic database includes known spectral data of neutral elements. The threshold removal rate may be determined based on one or more of the element candidates, sample type, and the vacuum level of the sample chamber during light emission. The threshold removal rate may alternatively be determined experimentally on a reference sample with known elemental composition. The standard atomic database and/or the standard ionic database may be obtained from data provided by NIST (National Institute of Standards and Technology). The standard databases may also include customized data obtained from previous experiments.

In some embodiment, in order to accelerate the spectral analysis, before preparing the element database, only element candidates that have at least one peak within a threshold distance from the selected peak are considered as element candidate for method 300. As such, the element database for analyzing each spectral peak analysis may be different.

At 304, an element candidate in the list of element candidates is selected. In one example, the selected element candidate may have a peak location close to the selected peak, that is, the peak selected at 212 of FIG. 2.

At 306, the selected spectrum is compared with data of the selected element candidate in the element database to determine whether all expected peaks from the element database are detected in the spectrum. For example, step 306 checks whether the spectrum include peaks at the expected peak locations. If any expected peak is not shown in the spectrum, method 300 proceeds to 310. If all expected peaks are shown in the spectrum, method 300 proceeds to 308 to check whether the expected peaks have matched peaks in the spectrum. The expected peaks are matched with peaks in the spectrum when the relative intensities among the expected peaks match the relative intensity of the peaks in the spectrum. If the peaks of the spectrum do not match the expected peaks, method 300 proceeds to 318. If the spectrum includes peaks match both the position (at 306) and the relative intensity (at 308) with the expected spectrum of the selected element candidate, method 200 may optionally check whether the selected element is included in the user inputted element list at 312. Alternatively, step 312 may be removed, and the method directly proceeds to 316 if the expected peaks match peaks in the spectrum at 308.

At 312, if the selected element candidate is included in the user inputted element list, method 300 proceeds to 316. Otherwise, the method proceeds to 318.

At 316, the selected element candidate is confirmed, and the confidence level of the selected element candidate is set to 1. The confidence level may be a value from 0 to 1, wherein 1 corresponds to the highest confidence and 0 corresponds to no confidence.

At 318, the selected element candidate is confirmed, and the confidence level of the selected element candidate is set to be less than 1. The value of the confidence level corresponding to an element may be determined based on the degree of match between the spectrum and the data associated with the element from the database. For example, the confidence level is higher for a first element candidate with the expected peaks matched with the spectrum at 308 but is not included in the user input at 312, comparing to a second element candidate with the expected peaks not matching the spectrum at 308. In another example, the confidence level will be higher for an element with expected peak location and height ratio compared to the same candidate of matching location, but unexpected peak height ratio.

At 310, if one or more expected peak is not detected in the spectrum at 306, method 300 checks whether any of the missed expected peaks has an expected peak level below the background signal intensity. The expected peak level can be determined based on intensity of the detected expected peak and relative expected peak intensities of the element candidate from the element database. The background signal intensity may depend on the noise level of the data acquisition. An expected peak may be missed in the spectrum when the expected peak level is low and the light collection system does not have the sensitivity to detect the missed peak. If the answer at 310 is YES, method 300 proceeds to 312 to optionally check whether the selected element candidate is included in the user inputted element list. Otherwise, if the answer at 310 is NO, the selected element candidate is declined and eliminated from the element candidates at 314.

After either confirm or decline the selected element candidate, at 320, method 300 selects another element candidate if there is any element candidate that has not been analyzed. If all element candidates have be analyzed, method 300 terminates. Otherwise, another element candidate is selected at 304. In one example, method 300 is terminated when all element candidates having at least one peak within a threshold distance from the selected peak have been analyzed.

In this way, elemental composition corresponding to the narrow peaks, that is, peaks resulted from elemental emission, is determined. The determined elemental composition includes one or more chemical element names, as well as a confidence level corresponding to each chemical element. The elemental composition determined in method 300 may be used for determining the elemental composition corresponding to the broader peaks in FIG. 4.

FIG. 4 shows method 400 for analyzing a spectral peak with width greater than the spectral resolution. These peaks may be the result of molecular emission, combination of elemental emissions, or bandgap emission. Method 400 first determines whether the peak corresponds to the molecular emission or the combination of elemental emissions. If the peak does not match either the molecular emission or the combination of elemental emissions, the peak is determined to originate from bandgap emission.

At 402, a molecular database is prepared. The molecular database includes data of molecular candidates. Each molecular candidate may correspond to one peak. The data corresponding to each molecular candidate may include the location of peak and relative intensity of the peak. The molecular candidate may be determined based on the element candidates generated at 210 of FIG. 2. The molecular candidate may include molecules having a spectral peak within a threshold distance from the peak under investigation. The data corresponding to the molecular candidates may be obtained from a standard database and/or from previous experiments.

At 404, one molecular candidate in the molecular database is selected.

At 406, method 400 checks whether the spectrum matches the data corresponding to the molecular candidate in the molecular database. For example, one or more peaks in the spectrum are compared with the known peak corresponding to the molecular candidate in the molecular database. If there is a match, method 400 proceeds to 410 and attribute the peak to molecular emission. Step 410 further includes identifying the elements corresponding to the molecular emission by decomposing the selected molecular candidate. Decomposing the selected molecular candidate includes identifying transitions from elemental components in the spectrum since molecules are likely to break apart during sputtering. For example, if the peak matches C-H molecular emission at 406, C and H are identified if the spectrum includes elemental emissions from C and H which can be used to increase confidence of molecular identification. Similarly, molecular identification may be used to increase confidence of candidate element peaks if the elements are linked to a molecular transition. If the peak does not match the selected molecular candidate at 406, method 400 moves to 408 to determine whether the spectrum corresponds to the combined elemental emissions. Emission from multiple elements may generate broad spectral peak when the elemental emission peaks of different elements are closely located or overlapped.

At 408, the elements that may contribute to the peak in the spectrum are identified, for example, based on an element database. In one example, the element database may be the same element database prepared in 304 of FIG. 3. In another example, the element database is the standard element base. Identifying the elements contributing to the peak includes identifying element candidates with peaks that can be combined to form the broad peak for the given spectral resolution. For example, if the spectral resolution is greater than the peak to peak distance from different element candidates, the identification may include comparing the peak to peak distance with the width of the broad peak, and checking whether the broad peak can be deconvoluted into a linear combination of peak ratios of different element candidates.

At 412, method 400 checks whether all of the identified elements at 408 are confirmed in method 300 of FIG. 3. If the answer is YES, the broad peak is attributed to be generated from elemental emission of multiple elements. The identified elements at 408 are confirmed. Further, a confidence level of less than 1 is set. If the answer at 412 is NO, method 400 proceeds to 414 to check whether other expected peaks of the identified elements are detected. If the answer at 414 is YES, method 400 proceeds to 416. If the answer is NO at 414, the emission type of the peak is determined to be bandgap emission at 418. One or more of the bandgap energy, electronic structure of the bulk conduction, and valence bands or defect states may also be determined based on the peak's location.

At 420, method 400 checks whether the identified elements through molecule decomposition at 410 are included in the user inputted element list. If the answer is YES, the identified elements at 410 are confirmed at 424, and the confidence levels of the identified elements are set to 1. If the answer is NO, the identified elements at 410 are confirmed at 422, and the confidence levels of the identified elements are set to a number smaller than 1.

At 426, method 400 checks whether all molecular candidates in the molecular database have been analyzed. If there is any molecular candidate left, another molecular candidate is selected at 404. Otherwise, method 400 exits.

In this way, elements corresponding to the broader peaks are identified after determining the emission type of these peaks. Peaks due to bandgap emission can also be determined.

FIG. 5 shows method 500 for further confirming presence of the identified elements in step 216 and/or step 218 of FIG. 2. A new spectrum of the sample is obtained. The removal rate for acquiring the new spectrum is different from the removal rate for acquiring the spectrum obtained at 202 of FIG. 2. One or more identified elements from steps 216 and/or 218 may be confirmed by comparing the new spectrum with the previously acquired spectrum. For example, if the new spectrum is acquired at a higher removal rate, the element may be confirmed if the change of spectral peaks in the new spectrum from the previous spectrum matches the expected change of the element.

At 502, the new spectrum of the sample is obtained. The new spectrum is acquired at a removal rate different from the removal rate for acquiring the spectrum obtained at 202 at FIG. 2. Obtaining the new spectrum may include loading the spectral data of the new spectrum stored in the memory for further processing in the processor. Obtaining the new spectrum may alternatively include acquiring the new spectrum at a second removal rate. The second removal rate may be chosen based on the element to be confirmed. The second removal rate may further be chosen based on the system parameters, as such as pressure in the vacuum chamber. The new spectrum may be collected at a same sample region, or a sample region close to the sample region generated the spectrum at 202 of FIG. 2. Alternatively, the new spectrum may be collected from a sample region with the same sample composition as the sample region generated the spectrum at 202 of FIG. 2.

At 504, previously determined composition information is optionally obtained. The information may include the confirmed elements from steps 216 and 218 of FIG. 2.

At 506, a second element database is prepared. The second element database may include known spectral data of selective elements that need to be further confirmed. The spectral data may include data of the selective elements from both the atomic database and the ionic database. The spectral data may include intensities of spectral peaks at various removal rates. The second element database may also include experimental data from previous measurements of samples of known composition. In one example, the selective elements are one or more element candidates included in the element database prepared at 304 of FIG. 3. In another example, the selective elements are one or more elements in the confirmed elements from steps 216 and 218 of FIG. 2. The second element database may be generated based further on the removal rate corresponding to the new spectrum. For example, data of the selective elements from the standard ionic database are included if the increased removal rate corresponding to the new spectrum.

At 508, an element candidate from the second element database is selected.

At 510, the new spectrum is compared with the previous spectrum to determine the observed spectral changes responsive to the change of removal rate. The observed spectral changes may include new peak locations and/or intensity change in one or more peaks. As shown in FIG. 8, spectra of Mg at different removal rates have different number of peaks, different peak locations, and different peak intensities.

At 512, the observed spectral changes determined at 510 are compared with expected spectral changes obtained from the second element database. The expected spectral changes may be obtained by comparing data of the element candidate at neutral and ionic state. If the difference of the observed spectral changes at 510 matches with the expected spectral changes, at 514, method 500 confirms the selected element candidate and set the confidence level to 1. Otherwise, method 500 proceeds to 516 to check whether there is any element candidate left to be analyzed.

At 516, if no element candidate is left, method 500 exits. Otherwise, another element candidate is selected at 508.

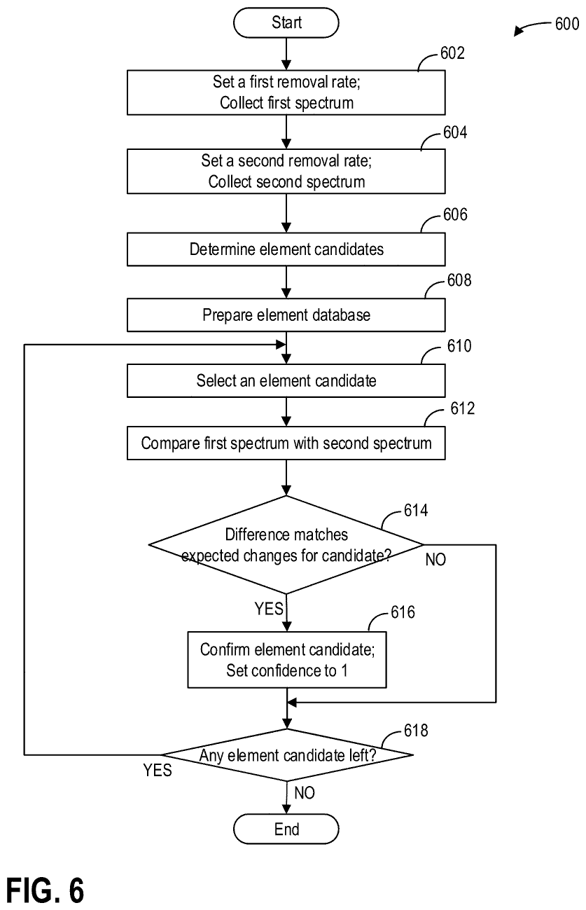

FIG. 6 shows method 600 for determining elemental composition of a sample based on at least two spectra acquired at different removal rates. The observed changes in the two spectra are compared with expected changes of a particular element candidate from the element database. If the observed changes match with expected changes, the element candidate is confirmed to be included in the sample under investigation.

At 602, the charged particle irradiates the sample at a first removal rate at a first sample location and collects a first spectrum using the light collection system. The removal rate may be adjusted by adjusting one or more of ion flux, beam energy, and ion mass/species. The ion flux may be adjusted by adjusting one or more of beam current, current density, dwell time, or scanned surface area.

At 604, the charged particle irradiates the sample at a second removal rate at a second sample location and collects a second spectrum using the light collection system. The first and second sample locations may be the same, close to, or adjacent to each other in the sample plane. The first and second sample locations may be spaced apart from each other if the sample composition is expected to be similar at the two sample locations. In some examples, the first removal rate is lower than the second removal rate.

At 606, element candidates are determined. The element candidates may be determined based on user input. The element candidates may also be determined based on previous experimental results of similar sample.

At 608, the element database is prepared based on the element candidates determined at 606. In one example, the element database includes known spectral data of neutral elements. In another example, the element database includes known spectral data of both neutral and charged elements. For example, the element database includes data from both atomic database and ionic database corresponding the element candidates. In other words, the known spectral data of the element candidates in neural and charged states are included in the element database. The spectral data may include peak location, relative peak intensities at different removal rates.

At 610, one element candidate of the element candidates determined at 606 is selected.

At 612, observed changes between the first and second spectra are determined by comparing the first and second spectra. The observed changes may include changes in location and intensity of identified peaks in the first and second spectra. The peaks may be identified via thresholding, similar to 208 in FIG. 2.

At 614, expected spectral changes of the element candidate responsive to different removal rates are determined from the element database. For example, the expected changes may be obtained by comparing expected change in spectral data of the element candidate between the two removal rates. If the expected spectral changes match the changes determined at 612, method 600 proceeds to 616 to confirm the selected element candidate. Further, the confidence level of the selected element candidate is set to 1. Otherwise, if the expected spectral changes do not match the observed changes, method 600 rejects the selected candidate and moves on to 618.

In some embodiments, if the changes are matched at 614, method may further check whether the selected element candidate is included in the user inputted element list. If the candidate is included in the element list, the selected element candidate is confirmed, and the confidence level is set to 1. If the candidate is not included in the element list, the selected element candidate is confirmed, and the confidence level is set a number lower than 1.

At 618, method 600 checks whether all element candidates have been analyzed. If no element candidate is left, method 600 exits. Otherwise, another element candidate is selected at 610.

In some embodiment, instead of collecting the spectra at 602 and 604, the spectra and corresponding removal rates information can be obtained by accessing stored data in a memory.

In some embodiment, the ion beam may scan a sample region (for example a region defined within the sample plane) at a lower removal rate to collect a first spectral dataset. The ion beam may then scan selected regions or sample locations within the sample region to collect a second spectral dataset. The first and second spectra collected at the same location in the sample plane may be compared to determine the elemental composition.

In some embodiment, more than two spectra of the same sample composition may be obtained or acquired, wherein each spectrum corresponds to a different removal rate. The observed change in the spectra can be compared to expected peak change of a particular element, in order to determine the sample's elemental composition.

The technical effect of determining sample composition based on FIB-IOE is that the FIB-IOE spectrum includes signals generated from multiple emission types including elemental emission, molecular emission and bandgap emission, which can reveal rich compositional information. The technical effect of determining the emission type of the peaks in the FIB-IOE spectrum is that a proper database may be constructed correspondingly to further determining the elemental composition that contributes to the spectral peak. The technical effect of determining the emission type based on a spectral resolution of the light collection system used for acquiring the spectrum is that peaks corresponding to the elemental emission can be analyzed first. Determining the elemental composition of the peaks corresponding to elemental emission can facilitate analyzing the broader peaks. The technical effect of spectroscopic analysis of FIB-IOE spectrum based on the removal rate for acquiring the spectrum is that the elemental composition can be accurately determined based on the different signal characteristics of neutral and charged element responsive to irradiation of different removal rates.

What is claimed is:

1. A method for spectroscopic analysis, comprising:
accessing a spectrum of light emitted from a sample responsive to irradiating the sample with an ion beam;
identifying one or more peaks of the spectrum; and
determining an emission type of at least one peak of the one or more peaks based on a spectral resolution of a light collection system used for collecting the spectrum, wherein the emission type includes an elemental emission, a molecular emission, and a bandgap emission.

2. The method of claim 1, wherein determining an emission type based on a spectral resolution of an imaging system includes determining the emission type being the elemental emission responsive to a peak width of the at least one peak not greater than the spectral resolution.

3. The method of claim 1, wherein determining an emission type based on a spectral resolution of an imaging system includes determining the emission type being the molecular emission or the bandgap emission responsive to a peak width of the at least one peak greater than the spectral resolution.

4. The method of claim 1, further comprising first determining the emission type of peaks with a width not greater than the spectral resolution, then determining the emission type of peaks with a width greater than the spectral resolution.

5. The method of claim 1, further comprising determining one or more elements corresponding to the elemental emission or the molecular emission.

6. The method of claim 5, further comprising assigning a level of confidence to each of the one or more elements.

7. The method of claim 5, wherein determining one or more elements corresponding to the elemental emission based on a removal rate used in acquiring the spectrum.

8. The method of claim 7, wherein determining one or more elements corresponding to the elemental emission based on a removal rate includes: comparing the spectrum with a first database responsive to a peak width of the at least one peak not greater than the spectral resolution, and the first database prepared based on the removal rate used in acquiring the spectrum.

9. The method of claim 5, wherein determining one or more elements corresponding to the molecular emission includes comparing the at least one peak with a second database responsive to a peak width of the at least one peak greater than the spectral resolution.

10. The method of claim 1, further comprising:
after acquiring the spectrum, adjusting a removal rate;
acquiring a second spectrum of light emitted from the sample responsive to irradiating the sample with the ion beam at the adjusted removal rate; and
determining elemental emission from neutral or charged element by comparing the second spectrum with the spectrum.

11. The method of claim 10, wherein adjusting the removal rate includes increasing the removal rate.

12. A non-transitory computer readable media, comprising instructions that, when executed by a processor, causes a computing device to:
access a first spectrum acquired responsive to irradiating a sample with an ion beam;
access hardware parameters for acquiring the first spectrum;
identify one or more peaks of the first spectrum; and
determine an emission type of at least one peak of the one or more peaks based on a spectral resolution of an imaging system for acquiring the first spectrum, wherein the emission type includes an elemental emission, a molecular emission, and a bandgap emission.

13. The non-transitory computer readable media of claim 12, comprising further instructions that, when executed by a processor, causes the computing device to determine the emission type based further on a removal rate for acquiring the first spectrum.

14. The non-transitory computer readable media of claim 12, comprising further instructions that, when executed by a processor, causes the computing device to:
access a second spectrum, wherein the second spectrum is acquired at an removal rate different from the first spectrum; and
determine one or more element corresponding to the one or more peaks by comparing the first spectrum and the second spectrum.

15. The non-transitory computer readable media of claim 12, comprising further instructions that, when executed by a processor, causes the computing device to determine the emission type of the peak to be the bandgap emission if the emission type of the peak is not the elemental emission or the molecular emission.

16. A charged particle microscope, comprising:
an ion source for generating an ion beam;
a sample holder for holding a sample;
one or more deflector for scanning the ion beam over the sample;
a light collection system for acquiring light emitted from the sample; and
a controller including a non-transitory computer readable media for storing computer readable instructions, by executing the instructions, the controller is configured to:
direct the ion beam towards the sample;
acquire a first spectrum using the light collection system;
identify one or more peaks of the first spectrum; and
determine an emission type of at least one peak of the one or more peaks based on a spectral resolution of the light collection system, wherein the emission type includes an elemental emission, a molecular emission, and a bandgap emission.

17. The system of claim 16, wherein the controller is further configured to determine one or more elements corresponding to the elemental or molecular emission based on a removal rate for acquiring the first spectrum.

18. The system of claim 17, wherein determine one or more elements corresponding to the elemental or molecular emission based on a removal rate for acquiring the first spectrum includes comparing the first spectrum with a database including an ionic emission database responsive to the removal rate higher than a threshold removal rate.

19. The system of claim 18, wherein the controller is further configured to determining the threshold removal rate based on a candidate element corresponding to the at least one peak.

20. The system of claim 16, wherein the controller is further configured to:
direct the ion beam towards the sample;
acquire a second spectrum using the light collection system; and
determine one or more elements corresponding to the one or more peaks by comparing the first spectrum and the second spectrum.
